(19) United States
(12) Patent Application Publication
(10) Pub. No.: US 2010/0217736 A1
(43) Pub. Date: Aug. 26, 2010

(54) Decision support method and apparatus for chaotic or multi-parameter situations

(76) Inventor: Oded Sarel, Even Yehuda (IL)

Correspondence Address: MARTIN D. MOYNIHAN d/b/a PRTSI, INC., P.O. BOX 16446, ARLINGTON, VA, 22215, US

(21) Appl. No.: 12/379,460

(22) Filed: Feb. 23, 2009

(51) Int. Cl. G06N 5/02; G06F 17/00

(52) U.S. Cl. 706/47; 706/46

(57) ABSTRACT

A scoring or alarm method for obtaining scores or alarms of multi-parameter situations comprises obtaining momentary values of parameters; and transforming the measured values into alarms, by: for each parameter defining a variation range; setting internal boundaries at any of substantially continuous locations along each variation range, said boundaries defining a plurality of internal regions within said variation ranges; allowing for user or rule input to configure and reconfigure said internal regions; providing scoring to respective ones of said internal regions; allowing for user or rule input to configure and reconfigure said scoring; defining a variation range of a total derived from said measured momentary values and associated internal region scores; providing at least one conversion rule for converting an internal region score currently associated with a measured input into a contribution to said total; allowing for user input to configure and reconfigure said at least one conversion rule; and providing an alarm according to an alarm rule associated with regions of said variation range of said total.

### FIELD AND BACKGROUND OF THE INVENTION

The present invention relates to a device and method for decision support which is capable of dealing with chaotic or multi-parameter situations.

Many processes and conditions are influenced by smaller or greater numbers of known parameters/variants, which change along the Time axis, resulting in a series of unsteady temporary states or situations. In the known art, when an extreme change occurs with one of the relevant parameters, an alert or a reaction can easily be performed, according to a predefined specific threshold.

Dynamic thresholds, of each parameter alone, have been described in U.S. Pat. No. 7,237,205 patent. In that case a thresholding solution for individual parameters was provided which included a boundary input device for setting boundaries in a variation range of the parameter of interest, thereby to define regions within the variation range. A label input device allowed for associating labels with the regions. A rule input device allowed for setting rules to associate different output recommendations with each of the regions and with combinations thereof, say combinations of different regions of different parameters. Finally an output device provided a user with an output recommendation associated with a region or combination thereof which corresponded with the at least one measured parameter input to the system and the dynamic boundaries set.

Thus the above art teaches thresholding for individual parameters to set regions, repeating the process for multiple parameters to provide different regions which would be entered simultaneously during a multi-parameter reading, and then providing an output recommendation based on the combination of regions achieved.

However in the above each parameter is dealt with individually and defines its own set of regions. The interaction between the parameters is only in terms of retrieval of rules associated with the different possible combinations of simultaneously attained regions. The above fails to provide a solution in cases where relationships between the parameters are not straightforward.

### SUMMARY OF THE INVENTION

According to one aspect of the present invention there is provided a measurement to alarm transformation apparatus, comprising:

a plurality of measurement inputs for obtaining momentary values of respective parameters;

an alarm output; and

a transformation unit for selectively transforming said measured momentary values into alarms, the transformation unit comprising:

an input scale for each parameter defining a variation range of said parameter;

a boundary input module, configured to set internal boundaries at any of substantially continuous locations along each input scale, said boundaries defining a plurality of internal regions within said variation ranges, said boundary input module allowing for user or rule input to configure and reconfigure said internal regions;

a scoring module configured to provide scoring to respective ones of said internal regions, said scoring module allowing for user or rule input to configure and reconfigure said scoring in association with respective internal regions;

a totalizer scale, defining a variation range of a total derived from said measured momentary values and associated internal region scores;

an input scale to totalizer converter comprising at least one conversion rule for converting an internal region score currently associated with a measured input into a contribution to said total, said converter allowing for user input to configure and reconfigure said at least one conversion rule; and

wherein the alarm output is associated with said totalizer scale, to output an alarm according to an alarm rule associated with regions of said totalizer scale.

In an embodiment, said input scale comprises a linear continuum.

In an embodiment, said conversion rule comprises summation of respective scores.

In an embodiment, said summation is subsequent to scaling of at least one of said scores.

In an embodiment, said scoring module is configured to use a rate of change over time of respective momentary values.

In an embodiment, said scoring module is configured to further use a history of a given parameter.

In an embodiment, said scoring module is configured to use an integral based on time spent by a parameter on a given side of a threshold.

In an embodiment, said totalizer scale comprises a continuum.

In an embodiment, said totalizer scale comprises an area, and said at least one conversion rule comprises placing each parameter at a location on said area, and defining output regions over said area, at least one of said regions being associated with said alarm.

In an embodiment, said totalizer scale comprises a volume, and said at least one conversion rule comprises placing each parameter at a location on said volume, and defining output regions within said volume, at least one of said regions being associated with said alarm.

According to a second aspect of the present invention there is provided a measurement to alarm transformation method, comprising:

obtaining momentary values of a plurality of parameters;

transforming said measured momentary values into alarms, by:
for each parameter defining a variation range of said parameter;
setting internal boundaries at any of substantially continuous locations along each variation range, said boundaries defining a plurality of internal regions within said variation ranges;
allowing for user or rule input to configure and reconfigure said internal regions;
providing scoring to respective ones of said internal regions;
allowing for user or rule input to configure and reconfigure said scoring;
defining a variation range of a total derived from said measured momentary values and associated internal region scores;
providing at least one conversion rule for converting an internal region score currently associated with a measured input into a contribution to said total;
allowing for user input to configure and reconfigure said at least one conversion rule; and

providing an alarm according to an alarm rule associated with regions of said variation range of said total.

According to a third aspect of the present invention there is provided a measurement to score transformation apparatus, comprising:

a plurality of measurement inputs for obtaining momentary values of respective parameters;

an alarm output; and

a transformation unit for selectively transforming said measured momentary values into alarms, the transformation unit comprising:

an input scale for each parameter defining a variation range of said parameter;

a boundary input module, configured to set internal boundaries at any of substantially continuous locations along each input scale, said boundaries defining a plurality of internal regions within said variation ranges, said boundary input module allowing for user or rule input to configure and reconfigure said internal regions;

a scoring module configured to provide scoring to respective ones of said internal regions, said scoring module allowing for user or rule input to configure and reconfigure said scoring in association with respective internal regions;

a totalizer scale, defining a variation range of a total derived from said measured momentary values and associated internal region scores;

an input scale to totalizer converter comprising at least one conversion rule for converting an internal region score currently associated with a measured input into a contribution to said total, said converter allowing for user input to configure and reconfigure said at least one conversion rule; and

wherein the alarm output is associated with said totalizer scale, to output an alarm according to an alarm rule associated with regions of said totalizer scale.

According to a fourth aspect of the present invention there is provided a measurement to scoring transformation method, comprising:

obtaining momentary values of a plurality of parameters;

transforming said measured momentary values into alarms, by:
for each parameter defining a variation range of said parameter;
setting internal boundaries at any of substantially continuous locations along each variation range, said boundaries defining a plurality of internal regions within said variation ranges;
allowing for user or rule input to configure and reconfigure said internal regions;
providing scoring to respective ones of said internal regions;
allowing for user or rule input to configure and reconfigure said scoring;
defining a variation range of a total derived from said measured momentary values and associated internal region scores;
providing at least one conversion rule for converting an internal region score currently associated with a measured input into a contribution to said total;
allowing for user input to configure and reconfigure said at least one conversion rule; and

providing an alarm according to an alarm rule associated with regions of said variation range of said total.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Implementation of the method and/or system of embodiments of the invention can involve performing or completing selected tasks manually, automatically, or a combination thereof. This refers in particular to tasks involving the control of the spectral equipment.

Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified diagram illustrating a first device according to an embodiment of the present invention;

FIG. 1B shows in greater detail a part of the device of FIG. 1A;

FIG. 2 shows a variation of the device of FIG. 1A with multiple scales arranged in separate dimensions;

FIG. 3 is a graph showing readings over a period of time for four different medical inputs and a total reading derived from the inputs, according to an embodiment of the present invention;

FIG. 4 is another graph showing alternative readings taken over a different time scale using embodiments of the present invention;

FIG. 5 is a simplified diagram showing interrelationships between inputs and output to explain how the total derivations of FIGS. 3 and 4 may be derived, according to an embodiment of the present invention;

FIG. 6 is a simplified diagram illustrating operation of the boundary setting module to change boundaries along an input (or for that matter output) scale, according to an embodiment of the present invention;

FIG. 7 is a simplified diagram illustrating operation of the scoring module to change scores for different internal regions of a scale according to an embodiment of the present invention;

FIG. 8 is a simplified diagram illustrating operation of the converter module to change contributions of input parameters to the output total, according to an embodiment of the present invention;

FIG. 9 is a simplified diagram illustrating an output totalizer based on a two dimensional area, according to an embodiment of the present invention;

FIG. 10 is a simplified diagram illustrating a scoring method according to the presently preferred embodiments in which a current score is based not only on a current measurement but also on a history of measurements, according to an embodiment of the present invention;

FIG. 11 is a simplified diagram showing a variation of the conversion module in which differentials or integrals of the parameter trace over time may be used as contributions to the totalizer; according to an embodiment of the present invention;

FIG. 12 is a screen capture showing a series of medical inputs and showing a sub-window for setting rules, according to an embodiment of the present invention; and

FIG. 13 is a simplified diagram illustrating how a boundary setting module can be used to convert a three-zone scale into a seven zone scale, according to an embodiment of the present invention.

### DESCRIPTION OF THE PREFERRED EMBODIMENTS

The present embodiments provide decision-making, assessment of situations which are affected by multiparameters and scoring, for example for purposes of comparison, for iinitiating alerts and for decision making. The present embodiments are pertinent in cases of evaluating changes where multiple parameters are involved, especially where there are relationships between different input parameters which are not straightforward, more particularly but not exclusively dynamic relationships. The present embodiments may combine and provide total scores for multiple parameters while there are dynamic scoring value changes in any of various zones defined for the parameters, and where the changes are for any parameter, according to the exact present circumstances. Moreover, the present embodiments provide a way of providing a total or overall score in the presence of dynamic relative changes in the weight of each parameter, so that the result remains relevant. The present embodiments further provide a way of assessing a multi-parameter situation that has not previously been accessible to computerized assessment methods.

The present embodiment deals with creating a common denominator enabling summation of different types of parameters—some digital, some analog, and others just in general not compatible. The present embodiment creates a methodology of converting any digital or analog data to the same scoring units, with rules dealing with the ever-changing relative affect of each of the parameters, in relation to the changes in measurements of particular parameters, and a dynamic of changes in importance between the parameters at any time.

Often a particular situation is measured using parameters which have nothing in common. The different parameters may be converted to scores having common units, wherein the score relates to the importance of the parameter to the situation being monitored. That is to say the old question of how to add apples and oranges is answered by taking the situation that is of interest, say nutrition. If the present embodiments were to applied to a diet, then the apples, oranges and any other food could be converted into common units of nutrition, say calories, vitamins, etc, quantities of proteins, fats, carbohydrates etc. and then the various units can be added in a way that scores the situation.

An overall solution for small or rapid changes in various relevant parameters, whether the individual changes are below or above pre-defined thresholds, for the purpose of providing analysis and follow up, may be considered necessary in many areas, such as:
Health situation continuous follow up;
Estimate of reactions to food products;
Estimate of environmental changes;
Stock exchange on line “barometer” for outside influences;
Irrigation systems;
Markets trend analysis. Business intelligence evaluation and follow up;
Risk evaluation. Underwriting—including medical and general; and
Quality assessment.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

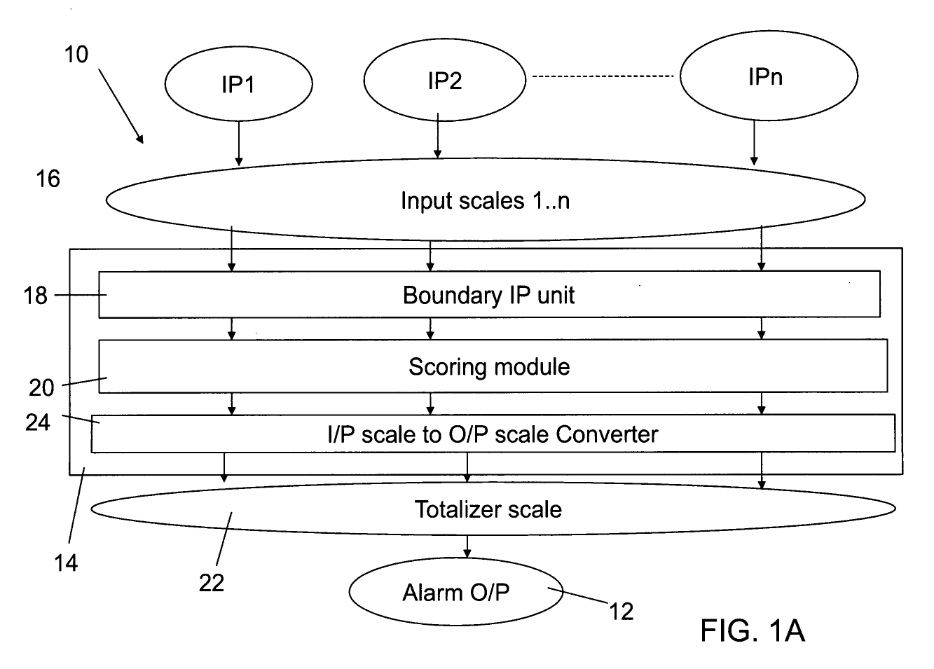

Reference is now made to FIG. 1A which illustrates measurement to alarm transformation apparatus 10. The system receives measurement inputs IP1 . . . IPn, of which at least some are momentary values of particular parameters that need to be measured. Other inputs may be user inputs or derivations of user inputs, for example from users filling in web forms or the like. An alarm output 12 provides alarms when conditions are met, but the conditions may involve a consideration of all of the inputs. An alternative is to provide an output that provides common denominator scoring. A transformation unit 14 selectively transforms the measured momentary values into alarms. As well as alarms, active outputs may be controlled.

The transformation unit 14 accepts the inputs mapped onto scales 16. Each input may have its own scale, the scale defining a variation range of the parameter. A boundary input module 18 allows internal boundaries to be set within the scales, for example at various substantially continuous locations along each input scale. Thus regions may be defined between the boundaries and thus within the variation ranges of the respective parameters. The boundary input module may include an interface for user input to set the boundary. Alternatively a rule may set the boundary or allow the boundary to change dynamically. A user input may allow a user to input or configure a rule.

A scoring module 20 may be used to provide a score to a region on the scale. The scoring module may include a user interface to allow a user to set a rule. The scoring module may allow a rule to set or change a score. The scoring module may include a user interface to allow a user to insert, edit or activate a rule for setting a score.

A totalizer scale 22 defines a variation range of a total or aggregation derived from the measured momentary values and the internal region scores associated with the measurements.

an input scale to totalizer converter 24 comprises conversion rules for converting an internal region score currently associated with a measured input into a contribution to the total on the totalizer scale 22. The converter may accept user input via a user interface or rule input. A rule interface may allow a user to configure, reconfigure, add, edit or delete the various conversion rules. The alarm output 12 is associated with the totalizer scale, and may output an alarm according to an alarm rule associated with regions of the totalizer scale.

In greater detail, the present embodiments comprise a system designed and developed to follow dynamic and complex situations with recurring multi-variant or even chaotic changes.

The presently described decision support system is designed to give a single grading and illustrate the current weighted total scoring of the current situation, emerging from N different dynamic parameters with dynamic relative weights.

Alternatively, the system may be based on assessing situations that were never previously accessible to computerized decision making or assessment of any kind. Analog and digital values can be compared instantaneously or over time to indicate changes in situations that may be dangerous or simply require attention.

The system is built up with three levels, each level being a grouping of rules, as follows:

Level A: Rule Group A—rules which control changes of the threshold positions between score zones according to current circumstances.

Level B: Rule Group B—rules which control changes of the scoring weights of each scoring zone according to current circumstances.

Level C: Rule Group C—rules which control changes of the relative parameter's weight/importance according to current the circumstances.

FIG. 1B illustrates the relationship between A group rules and B group rules in a single dimensional interaction in accordance with an embodiment of the present invention. A continuum 100 is divided into different zones 102 by thresholds or divider lines 104. The thresholds may be moved according to the A rules. Each of the zones 102 is associated with a score 106. The scores may be varied according to the B group rules.

Each relevant parameter/variant is introduced in a scale or continuum 100 which is divided into scoring zones 102. The threshold between the zones may be moved up or down according to Rule Group A. Rule group A may for example make use of:

a relevant data base;

a formula;

a time interval dependency; or

a graph-based dependency, for example a parameter cumulative values curve, an up or down slope dependency, or an area dependency.

Having established the boundaries of each zone, the zone may now receive a respective scoring value according to Rule Group B. Sources for the score may for example include:

a specific or general data base;

the parameter may be affected by its constant or temporary importance and/or weight according to predefined circumstances;

a formula.

Parameters may be divided into numeric parameters and transformed parameters. Numeric parameters may be measured by units, and are easily made into a scale such as continuum 100. Transformed parameters may comprise transformation from an analog description to digital scoring, using a predefined scale. Questions asked to patients may invite numerical answers which can be considered as transformed parameters. For example: the patient may be asked to scale the pain he is in to between 1-10; or to scale a general feeling in between 1-5. Alternatively responses may be to a sound or to an image.

Giving a grade to each zone provides an infrastructure in which different parameters can be used in the same way and compared with each other. Changes may be made to the scoring system while retaining the same units and the same base line.

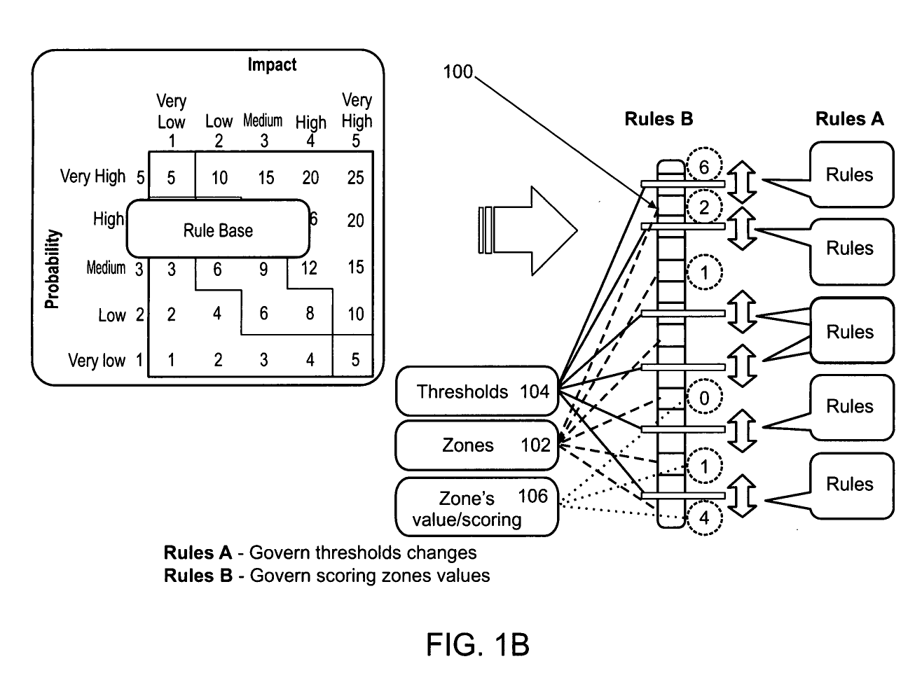

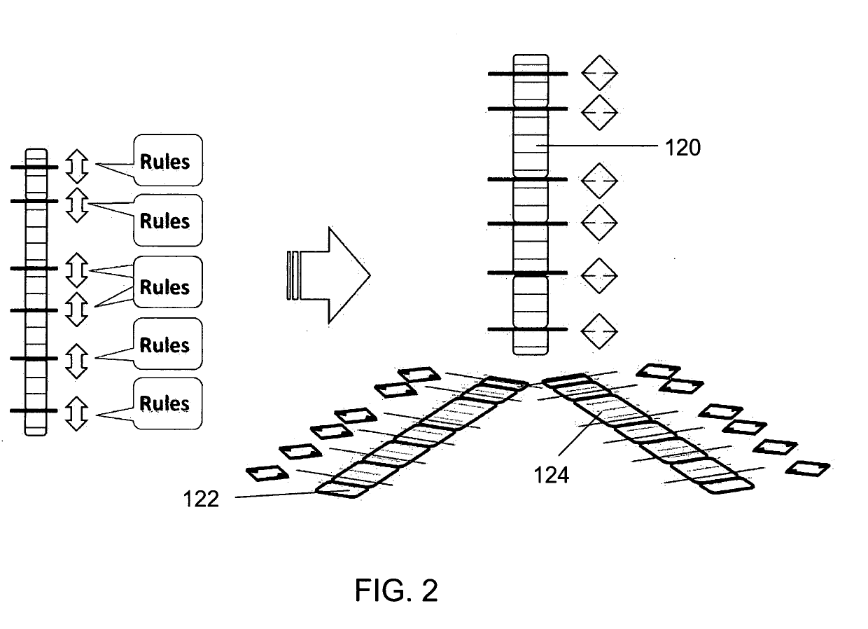

Reference is now made to FIG. 2 which illustrates three such scales or continua, 120, 122, and 124 sharing a single origin and orthogonally located in a three-dimensional volume, according to an embodiment of the present invention. A total score may be calculated from the momentary combination of currently indicated zones from each parameter. The result is a total score at a given Time, hereinafter referred to as a situation. Evolution of the situation may be illustrated on a Time dependent axis, as in FIG. 3 showing daily evolution of four parameters, HR, temperature, drinking and nausea. A total is also plotted, according to an embodiment of the present invention. An area may be measured or any other suitable way used of totaling the different parameters.

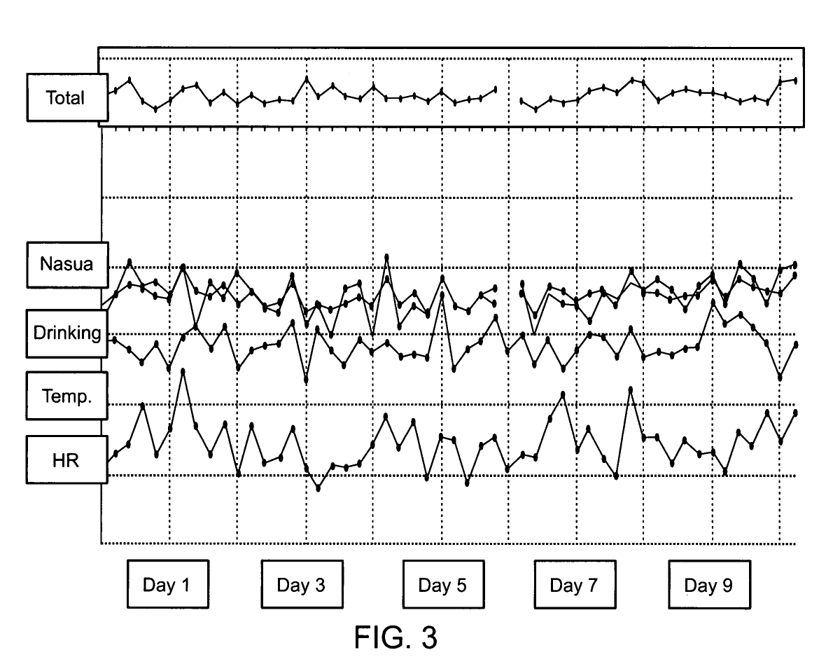

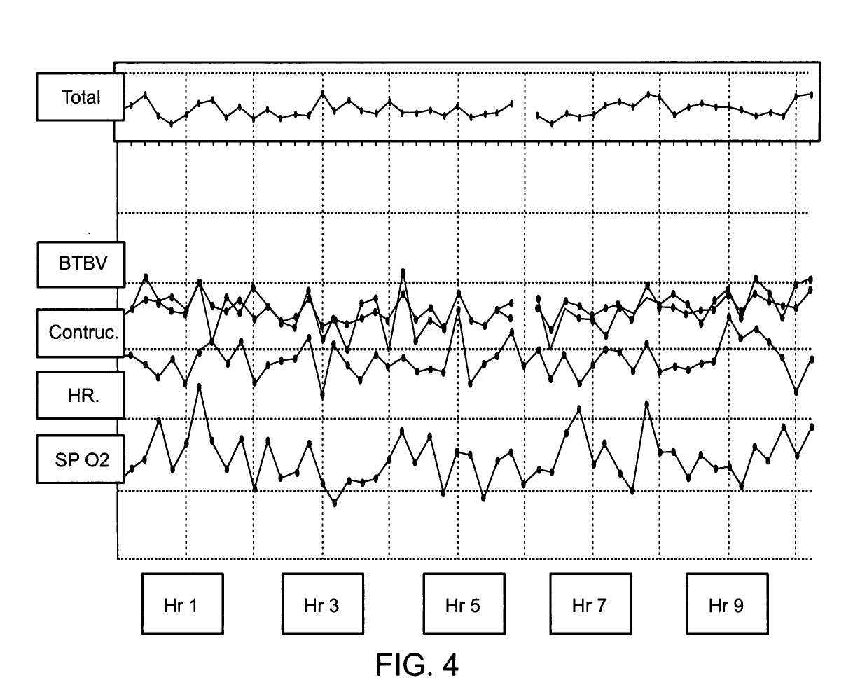

FIG. 4 illustrates hourly evolution of beat to beat variation (BTBV), contraction strength of the heartbeat (Contruc), Hand Rate (HR) and Oxigen saturation-SP 0₂. Again a total is shown at the top of the graph, in accordance with an embodiment of the present invention. Reference is now made to FIG. 5, which is a simplified diagram showing dynamic changes in three different variables being fed into a total, according to an embodiment of the present invention. Three variables, drinking, temperature and HR show minor changes over a given time scale. The changes are fed to the total which accumulates the changes. In this particular case the accumulation leads to a significant change and is given a high score. Rule Group C, as defined above, governs the different parameters' relative weights or levels of importance, and thus defines what changes are considered as important.

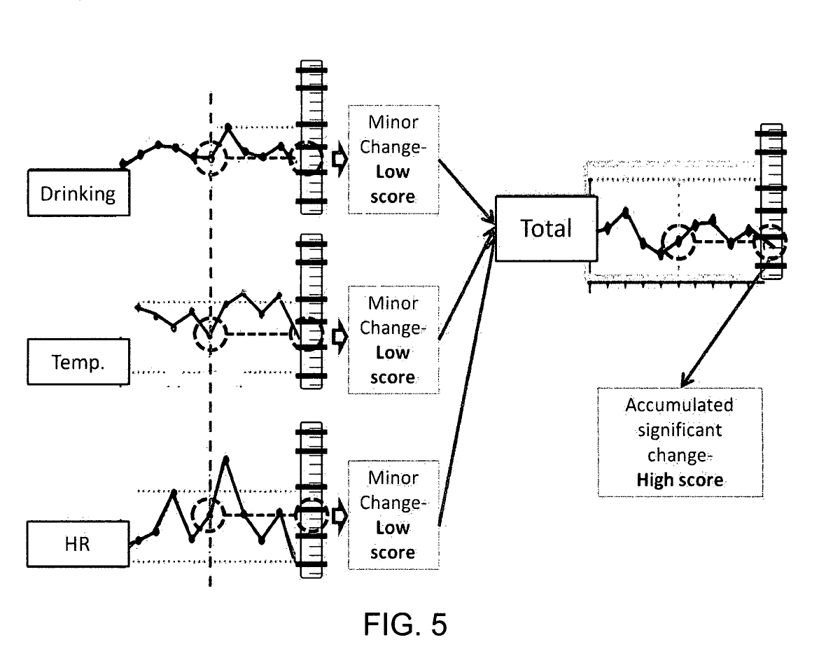

Reference is now made to FIG. 6 which shows one way in which a single continuum may be modified, according to an embodiment of the present invention. The continuum 130 on the left hand side is modified by moving the thresholds 132 in accordance with arrows 134, so that the continuum 136 on the right hand side is obtained. Thus, it is possible to insert rules regarding relevant conditions which may influence the thresholds position. Such added rules would be part of Rule Group A. Adding such rules provides a dynamic method to adopt multi-factorial changes affecting the actual scoring of an actual change in the parameter value, by moving the threshold position or value. The process may be repeated indefinitely as shown by arrows 138.

Examples for rules in group A:

1. Moving the threshold or changing its location manually.

2. Moving the threshold location according to the magnitude of changes in a parameter values in between two measurements as a function of the duration of the time in between those two measurements.

E.G.—move up or down the threshold by P points according to the following function

P=[magnitude of the change in %]×[1/the time interval in between two measurements]×pre defined constant

3. A threshold changes according to a formula, which creates an unsteady threshold behavior.

E.G.—Changes according to the hour of the day, in a predefined formula, such as a sine curve. One type of potential curve may use a sinusoidal function as follows:

P=pre defined constant A×Sin(π/12×t+π/2)±Constant B, where P represents the value of change and t represents the actual time during a 24 hour day.

4. Changes of a threshold location according to related or non-related data in a predefined database.

E.G.—(1) Definition of threshold may involve taking weight values in kg against Height in cm. The definition may include the thresholds themselves and also provide values for scoring of the different zones.

(2) Allocation of threshold location for a Hemoglobin value in g % versus age (years), and versus gender. Again the definition may include the thresholds themselves and provide values for scoring of the different zones.

5. Changes of a threshold location related to the magnitude of change in another parameter, sometimes a current and sometimes a previous value.

E.G.—Daily urine volume (in dl) in relation to Creatinine level in the blood (in mg %). A function may relate the two parameters, say such as in example 2 above, and would reflect the real life situation that the importance of change in one really depends on what is happening with the other, so that a certain change or level in one is of no interest by itself but when the other is at a certain level then it becomes much more important—or vice versa. Such a formula may for example be a reciprocal linear or exponential function which multiplies the daily/hurly urine volume changes, say by (−1).

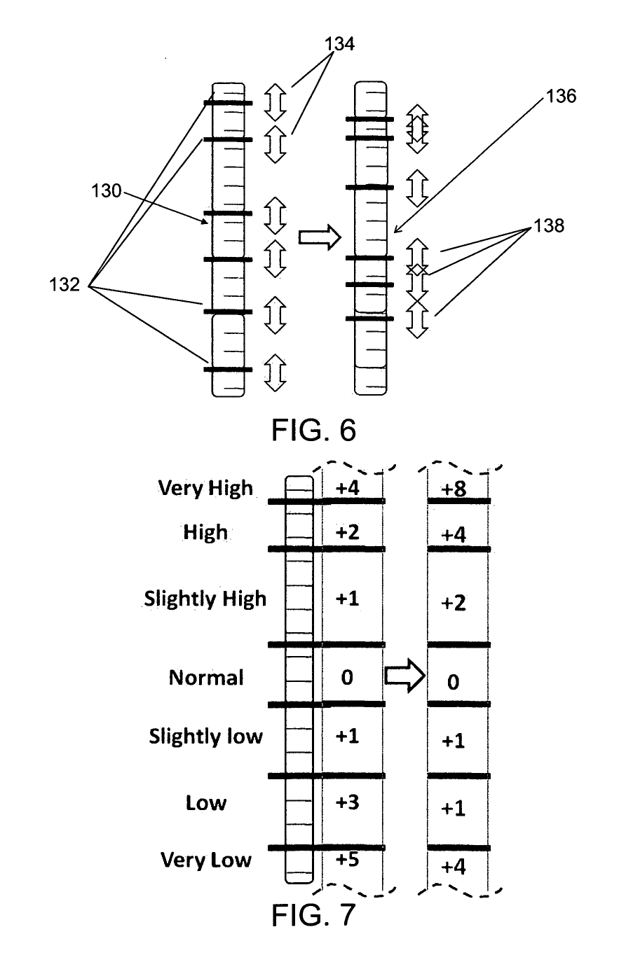

Reference is now made to FIG. 7, which illustrates different regions on a continuum and shows a process of assigning and then changing scores in connection therewith, according to an embodiment of the present invention.

Rule Group B contains rules, definitions, formulas etc related to factors which may affect the scoring of individual zones.

Examples for rules in group B:

1. Changing zone value manually.

2. Changes of a zone value according to related or unrelated data in a predefined database.

E.G.—Scoring of weight values in kg versus Height in cm, including thresholds and differential scoring for zones.

Scoring Hemoglobin value in g % versus age (years), and versus gender, including the thresholds and differential scoring for zones.

3. Changes of a zone value related to magnitude of change in another parameter, whether a current or previous value.

E.G.—Daily urine volume (in dl) in relation to Creatinine level in the blood (in mg %). A function may relate the two parameters, say such as in example 4 below, and would reflect the real life situation that the importance of change in one really depends on what is happening with the other, so that a certain change or level in one is of no interest by itself but when the other is at a certain level then it becomes much more important—or vice versa. Such a formula may for example be a reciprocal linear or exponential function which multiplies the daily/hurly urine volume changes, say by (−1).

4. Changing of a zone value according to the magnitude of changes in parameter values in between two measurements as a function of the duration of the time in between those two measurements.

E.G.—change zone scoring value in P points according to the following function—

P=[magnitude of the change in %]×[1/the time interval in between two measurements]×pre defined constant

5. A zone scoring value changing according to a formula, which creates an unsteady zone scoring value.

E.G—Changes according to the hour of the day, using a predefined formula such as a sine curve. Thus one type of potential curve may be the following sinusoidal function: P=pre defined constant A×Sin (π/12×t+π/2)±Constant B, where P is the value of change and t represents the actual time during a 24 hour day.

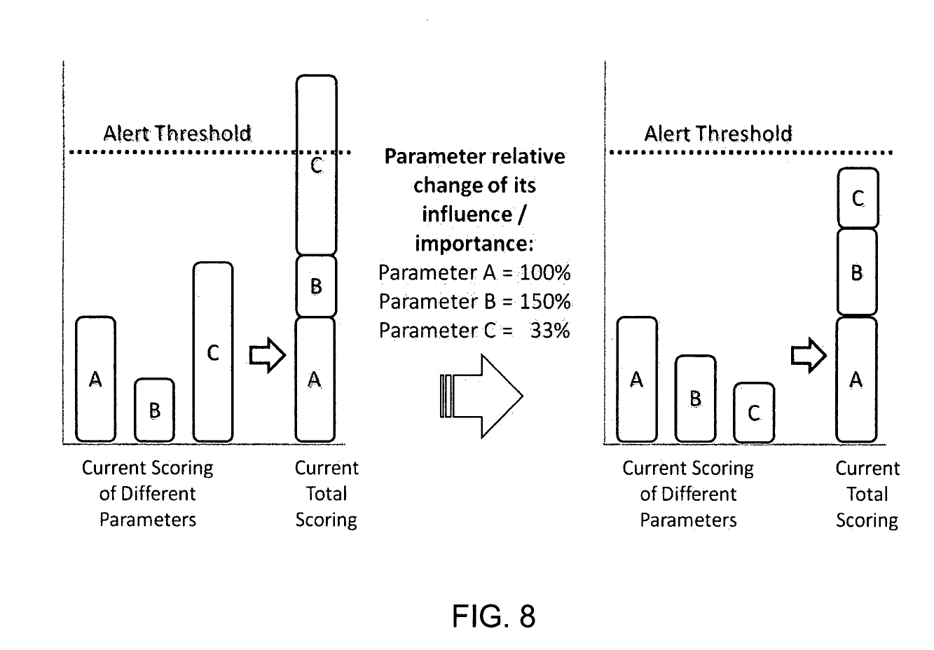

Reference is now made to FIG. 8, which is a simplified diagram illustrating how the relative influence of different parameters may be adjusted to give a different overall result, according to an embodiment of the present invention. Parameters A, B and C, when added up naively give a total which exceeds an alert threshold. However, after applying factoring to the parameters as shown, the alert threshold is no longer reached.

As explained above, Rule Group C is used to affect the relative importance of each parameter to the Total Scoring calculation. Thus rule group C may adjust the actual scores by adding, subtracting or multiplying (dividing) by factors. In FIG. 8, multiplication by a factor is shown by way of example.

Examples for rules in group C:

1. Manually changing.

2. Changes in the relative importance of a parameter according to related or non-related data in a predefined database.

E.G.—Body temperature changes may be given a higher importance in predefined pathological/medical conditions, such as low white blood cell count, immune deficiency situation, metastatic carcinoma, congestive heart failure.

Weight changes may be given a higher importance in predefined pathological/medical conditions, such as congestive heart failure, liver failure, renal (kidney) failure.

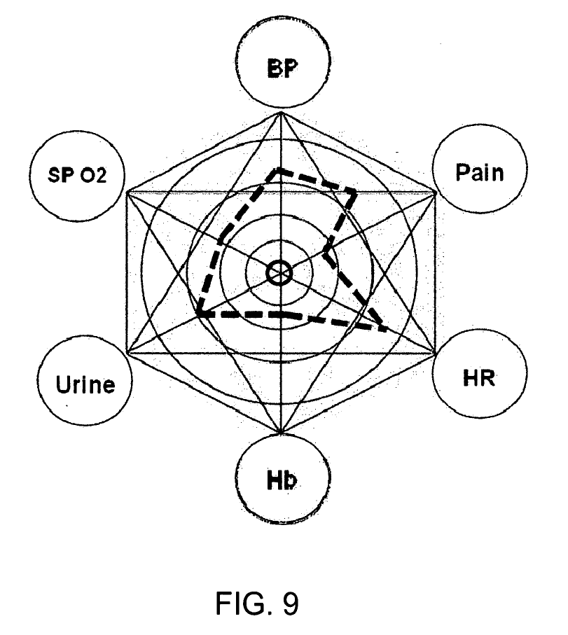

Total scoring of the momentary situation may be represented in a number of ways, for example, a single value may be obtained, as implied by the previous examples. Another possibility is that illustrated by FIG. 9. In FIG. 9 the parameters, BP, SP 02 etc. are placed around a center 150. Various regions are defined around the center and measurements (or adjusted measurements as per C group rules) are used to plot a location within the circle. The location may be within a region considered as safe, or a region of concern.

Instead of an area, the parameters may be placed around an N dimensional space, with regions of safety, concern and danger being defined in the same way.

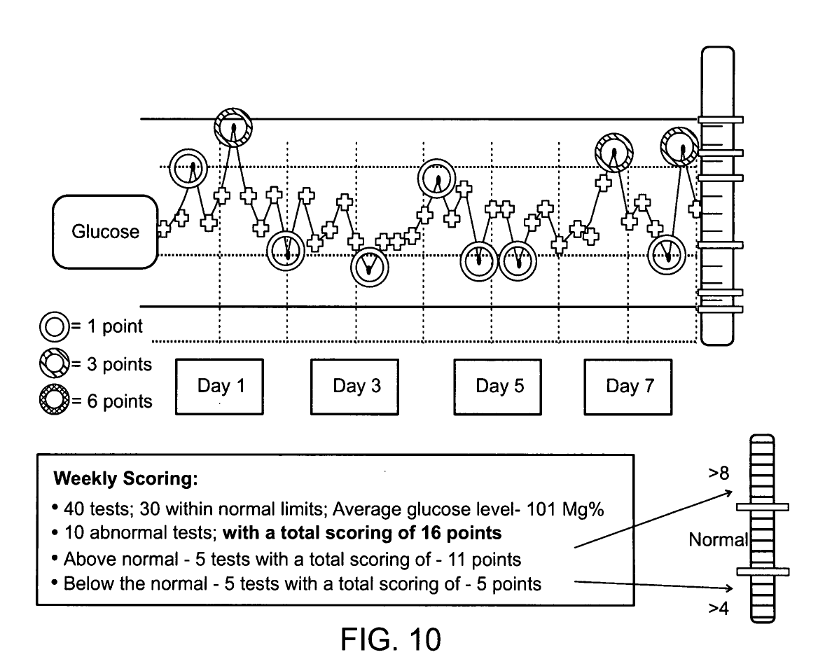

Reference is now made to FIG. 10 which illustrates periodic measuring of a particular parameter and scoring based on an accumulation of measurements over a period of time, according to a preferred embodiment of the present invention. The embodiment of FIG. 10 thus provides an ability to perform periodic accumulated scoring, to provide an alert when say the danger signal does not exceed a threshold per se, but rather the amount of time or the number of incidents of exceeding the threshold.

There are a number of ways to score results of single or multiple parameters along a predefined period/s of time to provide periodic accumulated scoring. Examples include the following:

Simple scoring by adding scores each time the threshold is exceeded. This may involve multiple measurements along predefined periods of time. FIG. 10 is a simplified example of such simple scoring based on glucose measurements. Forty tests were made. Thirty of them were normal. Of the remaining ten, shown ringed, scores were taken. An accumulation of 11 points above and 5 points below the thresholds gives a score of 16.

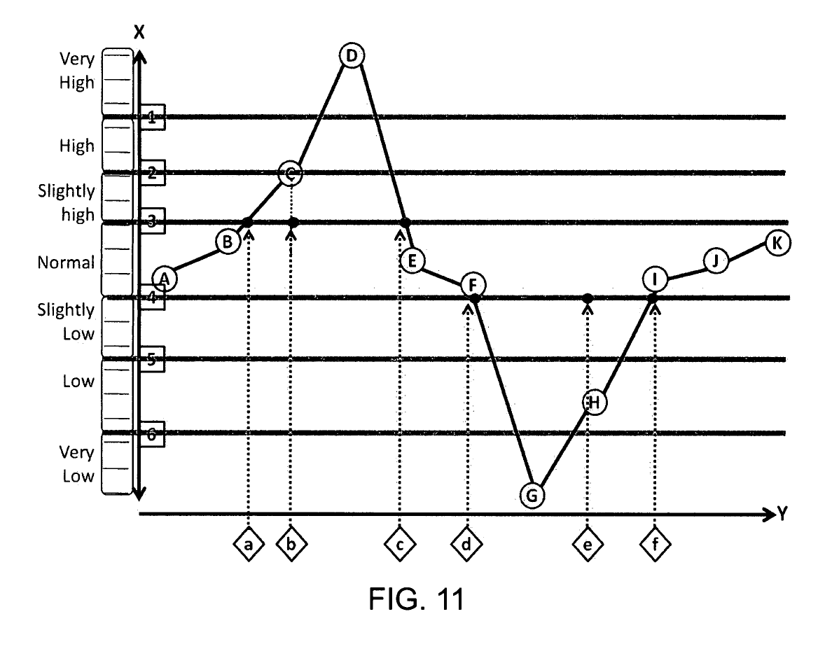

Reference is now made to FIG. 11, which is a simplified diagram illustrating measurement over time based on rate of change, according to an embodiment of the present invention. As per FIG. 11, an alternative method of scoring involves calculating of a rate of changes, that is to say a slope, or a differential, in between two successive or non-successive measurements. The method may involve calculating the average and the maximum positive and negative slope, the differential, per a given time period. An additional designated scale with predefined zones and threshold can be used for illustrating the change rate or slope.

FIG. 11 shows a graph of the results (measurements), or the scoring of the results [in capital letters], versus the thresholds themselves [in numerals]. The X Axis represents the scoring or the active measurements of the parameter in the relevant unit. The Y Axis is time. Small letters indicate points where the graph cuts the upper and lower normal value thresholds.

FIG. 11 illustrates an example of the rate of change—the slope calculation approach. In this example the positive rate of change is calculated by dividing scoring or measurement C (X,Y) by B (X,Y), or D (X,T) by C (X,Y). The negative rate of change is calculated by dividing G (X,Y) by F (X,Y).

The rate of change in scoring of the measurements, or results or even the straightforward scores can be obtained by using other methodologies, for example the normal differential function between the two relevant points in the graph, when the function or the approximate function of the results is available.

Another alternative involves calculation of the area above or beyond the graph—say between consecutive measurements of a given parameter, indicating being above or beneath a threshold, that is to say a measurement of the area bounded by the graph and the threshold that is exceeded. A designated scale with predefined zones and threshold can be used for illustrating the scoring or the magnitude of the area exceeding the threshold along the Y or time axis.

FIG. 11 illustrates a way of carrying out the extra-threshold area calculation. In this example a simple calculation of the area between—[aCb] plus [bCDc] represents the area above the upper normal threshold. [aCb]—is the area of the slightly high result. [bCDc]—is the area of the high result. The area of [dGHe] plus [eHf] is the area beneath the lower normal threshold. [dGHe]—is the area of the very low result, and [eHf] is the area of the low result.

An area calculation may be obtained by other methodologies, such as using an Integral function, when the function or the approximate function of the results exists. Areas can also be found by numerical techniques if the function is not known analytically.

Use of the above embodiments is now illustrated in non-limiting manner by reference to the following examples.

### EXAMPLE 1

### Clinical Watch

The monitoring of clinical conditions traditionally compares the patient's values to a pre-defined norm. To date, no medical tool enables the monitoring of slight changes in a range of parameters, or monitoring small changes over prolonged periods of time. This is because the multiplicity of small changes taken individually does not justify medical attention. Today, such monitoring is done by physicians with no indicators from an automated computer system.

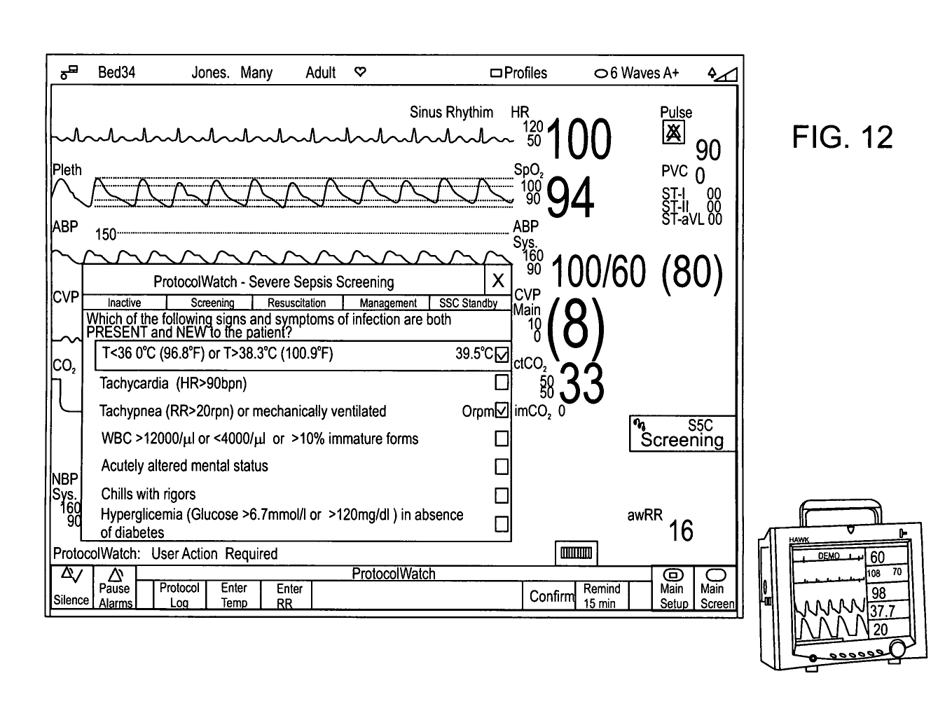

Reference is now made to FIG. 12, which is a simplified screen shot of a data gathering setup screen according to an embodiment of the present invention. A sub-window allows for setting of rules. Patient follow up, whether it is intensive due to a critical condition, or durable for chronic conditions, is usually multi-factorial and depends upon a number of different sources:

Digital data as indicated by FIG. 12, such as—

Measurements from various medical devices/sensors, including but not exclusively vital signs such as—blood pressure, heart rate, EKG, SpO2, body temperature, respiratory rate, FEV1, and body weight.

laboratory results, such as—blood Hemoglobin level, blood sugar level, Urine Ph, Blood gas levels.

Analogous information, such as current patient's complaints, Physical Examination, level of consciousness, general activity level, strength of muscles, etc.

Conventionally, a physician processes the information emerging from all the sources in his/her mind to determine a momentary conclusion—which is generally expressed using a descriptive remark with or without action item/s. A typical physician uses standardized and accepted thresholds to determine an extreme situation, which may then lead to any kind of medical reaction. Sometimes he/she follows a professional guideline. Current devices already use Upper and Lower Limits based on these same guidelines—thus providing thresholds for some of the collected parameters, and then automatically provide alerts when the actual measurement exceeds those thresholds.

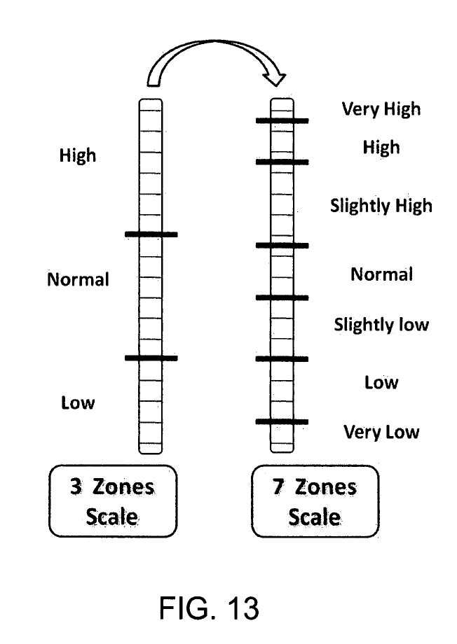

FIG. 13 illustrates a scale of a measured parameter, for example O₂ saturation in the blood). On the right hand side a Three (3) Zones Scale is shown, with upper and lower thresholds of standard acceptable values. On the left hand side, the same scale has been modified into a Seven (7) Zone Scale, with a more delicate and refined scale partition.

Giving a grade to each zone, as per the above-described embodiments, enables different parameters to be used, or allows changes of the scoring levels using the same units and on the same base line. In one example the same parameter could be read on the three zone scale and on the seven zone scale, depending on the circumstances.

A patient medical database may centralize information obtained from different medical institutions or doctors for individual patients. The database may only be looked at infrequently by an actual doctor but information of importance may emerge over time from changing parameters. Use of the present embodiments allows for regular monitoring of such medical databases.

Individual medical databases can be studied using the present embodiments. In addition whole classes of patients can be looked at. The system allows for normalization of measurements so that patients can be studied in groups.

Use of medical databases for population studies is made possible by the present embodiments.

### EXAMPLE

### Monitoring a Patient with Chronic Cardiac Insufficiency

Monitoring the class of patients with chronic cardiac insufficiency requires consideration of a range of parameters. Some of those parameters are parameters that can straightforwardly be accessed by sensors with digital outputs—weight, pulse, oxygen saturation etc. Some parameters may be more difficult to acquire in this way viz. number of pillows used during sleep, short breath symptoms, weakness, strong heart beat events, discomfort in the chest area, etc.

The analogue parameters can be converted to digital by asking a user to insert a score of 1 to 5 or 1 to 10 or through scoring a list of answers in a multiple choice questionnaire or through similar user interfacing techniques. Each parameter may be placed on a digital scale, as shown in FIG. 5 above. The medical staff receive readings for all parameters, including the individual score and a weighted score. As FIG. 5 shows, small changes can build into significant changes, depending on the relative weight assigned to each parameter and the scoring of each change. The measurement can also provide an index for deviation from a desirable situation and any need for prompt response of the medical staff. A periodic follow-up can also be programmed to generate alerts for accumulated changes in one or more parameters, as shown in FIG. 10, referred to above.

### EXAMPLE

### Monitoring an ICU or Hospitalized Patient

The patient is usually connected to various medical sensors which provide graphical and digital information to control displays. A lower and upper threshold can be defined for each parameter. Using the present embodiments, each parameter may have N zones, for example seven zones as shown in FIG. 13 to enable refinement of the changes. Staff monitor displays with multiple data but of course would find it difficult to react to an aggregate of small changes. The embodiment thus aggregates the changes to trigger a clear alert as appropriate. This is particularly desirable as it is likely that a single staff member may need to monitor several patients concurrently. The present embodiments may enable the staff member to monitor slow or accumulated deterioration of the patient's condition, allowing for an earlier response.

### EXAMPLE

### Irrigation Control System

Irrigation control systems are conventionally operated by a sensor which indicates the dryness level of the soil. The present embodiments may allow prediction of the need for irrigation using an aggregate of additional parameters: for example air moisture level, the infra red signal emitted by plants and the soil's moisture. Here too, an aggregate of small changes can indicate a need to irrigate before the soil has gone completely dry.

### EXAMPLE

### Evaluation of Business Trends in a Given Market

the decision whether to invest or abandon a certain investment market is generally triggered by prominent, unequivocal events. The present embodiments allow the use of a series of parameters, e.g. sales level, investment level, number of new patents in the field, number of contracts announced, change in the number of consumers, entry of new players, or any other factor the user may consider relevant, to generate an indication of the significance of gradual changes taking place in a given market. Using the present embodiments, it is relatively straightforward to add or remove a particular factor.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Measurement to alarm transformation apparatus, comprising:
a plurality of measurement inputs for obtaining momentary values of respective parameters;
an alarm output; and
a transformation unit for selectively transforming said measured momentary values into alarms, the transformation unit comprising:
an input scale for each parameter defining a variation range of said parameter;
a boundary input module, configured to set internal boundaries at any of substantially continuous locations along each input scale, said boundaries defining a plurality of internal regions within said variation ranges, said boundary input module allowing for user or rule input to configure and reconfigure said internal regions;
a scoring module configured to provide scoring to respective ones of said internal regions, said scoring module allowing for user or rule input to configure and reconfigure said scoring in association with respective internal regions;
a totalizer scale, defining a variation range of a total derived from said measured momentary values and associated internal region scores;
an input scale to totalizer converter comprising at least one conversion rule for converting an internal region score currently associated with a measured input into a contribution to said total, said converter allowing for user input to configure and reconfigure said at least one conversion rule; and
wherein the alarm output is associated with said totalizer scale, to output an alarm according to an alarm rule associated with regions of said totalizer scale.

2. The apparatus of claim 1, wherein said input scale comprises a linear continuum.

3. The apparatus of claim 1, wherein said conversion rule comprises summation of respective scores.

4. The apparatus of claim 3, wherein said summation is subsequent to scaling of at least one of said scores.

5. The apparatus of claim 1, wherein said scoring module is configured to use a rate of change over time of respective momentary values.

6. The apparatus of claim 1, wherein said scoring module is configured to further use a history of a given parameter.

7. The apparatus of claim 5, wherein said scoring module is configured to use an integral based on time spent by a parameter on a given side of a threshold.

8. The apparatus of claim 1, wherein said totalizer scale comprises a continuum.

9. The apparatus of claim 1, wherein said totalizer scale comprises an area, and said at least one conversion rule comprises placing each parameter at a location on said area, and defining output regions over said area, at least one of said regions being associated with said alarm.

10. The apparatus of claim 1, wherein said totalizer scale comprises a volume, and said at least one conversion rule comprises placing each parameter at a location on said volume, and defining output regions within said volume, at least one of said regions being associated with said alarm.

11. Measurement to alarm transformation method, comprising:
obtaining momentary values of a plurality of parameters;
transforming said measured momentary values into alarms, by:
for each parameter defining a variation range of said parameter;
setting internal boundaries at any of substantially continuous locations along each variation range, said boundaries defining a plurality of internal regions within said variation ranges;
allowing for user or rule input to configure and reconfigure said internal regions;
providing scoring to respective ones of said internal regions;
allowing for user or rule input to configure and reconfigure said scoring;
defining a variation range of a total derived from said measured momentary values and associated internal region scores;
providing at least one conversion rule for converting an internal region score currently associated with a measured input into a contribution to said total;
allowing for user input to configure and reconfigure said at least one conversion rule; and
providing an alarm according to an alarm rule associated with regions of said variation range of said total.

12. The method of claim 11, wherein said conversion rule comprises summation of respective scores.

13. The method of claim 12, wherein said summation is subsequent to scaling of at least one of said scores.

14. The method of claim 11, wherein said scoring is associated with a rate of change over time of respective momentary values.

15. The method of claim 14, wherein said scoring is associated with an integral based on time spent by a parameter on a given side of a threshold.

16. The method of claim 11, wherein said scoring is further associated with a history of a respective parameter.

17. The method of claim 11, wherein said totalizer scale comprises a continuum.

18. The method of claim 11, wherein said totalizer scale comprises an area, and said at least one conversion rule comprises placing each parameter at a location on said area, and defining output regions over said area, at least one of said regions being associated with said alarm.

19. The method of claim 11, wherein said totalizer scale comprises a volume, and said at least one conversion rule comprises placing each parameter at a location on said volume, and defining output regions within said volume, at least one of said regions being associated with said alarm.

20. Measurement to score transformation apparatus, comprising:
a plurality of measurement inputs for obtaining momentary values of respective parameters;
an alarm output; and
a transformation unit for selectively transforming said measured momentary values into alarms, the transformation unit comprising:
an input scale for each parameter defining a variation range of said parameter;
a boundary input module, configured to set internal boundaries at any of substantially continuous locations along each input scale, said boundaries defining a plurality of internal regions within said variation ranges, said boundary input module allowing for user or rule input to configure and reconfigure said internal regions;
a scoring module configured to provide scoring to respective ones of said internal regions, said scoring module allowing for user or rule input to configure and reconfigure said scoring in association with respective internal regions;
a totalizer scale, defining a variation range of a total derived from said measured momentary values and associated internal region scores;
an input scale to totalizer converter comprising at least one conversion rule for converting an internal region score currently associated with a measured input into a contribution to said total, said converter allowing for user input to configure and reconfigure said at least one conversion rule; and
wherein the alarm output is associated with said totalizer scale, to output an alarm according to an alarm rule associated with regions of said totalizer scale.

21. Measurement to scoring transformation method, comprising:
obtaining momentary values of a plurality of parameters;
transforming said measured momentary values into alarms, by:
for each parameter defining a variation range of said parameter;
setting internal boundaries at any of substantially continuous locations along each variation range, said boundaries defining a plurality of internal regions within said variation ranges;
allowing for user or rule input to configure and reconfigure said internal regions;
providing scoring to respective ones of said internal regions;
allowing for user or rule input to configure and reconfigure said scoring;
defining a variation range of a total derived from said measured momentary values and associated internal region scores;
providing at least one conversion rule for converting an internal region score currently associated with a measured input into a contribution to said total;
allowing for user input to configure and reconfigure said at least one conversion rule; and
providing an alarm according to an alarm rule associated with regions of said variation range of said total.

22. The method of claim 11, comprising setting up said conversion rule to convert respectively different parameters to contribute to said total in proportion to the contribution of each parameter to a patient condition of interest.

23. The method of claim 11, comprising dynamically varying said conversion rule to accommodate changing relative effects of each of the parameters, thereby to change a contribution of a respective parameter to said total in proportion to present changes in measurements of a respective parameter, and a dynamic of changes in importance between said respective parameter and other parameters.

24. The method of claim 23, comprising dynamically changing said internal boundaries based on a time interval dependency, thereby at least partly causing said dynamic varying to said conversion rule.

25. The method of claim 23, comprising dynamically changing scorings associated with respective internal regions based on a time interval dependency, thereby at least partly causing said dynamic varying to said conversion rule.

26. The method of claim 23, comprising dynamically changing scorings associated with respective internal regions based on a formulaic relationship with another parameter, thereby at least partly causing said dynamic varying to said conversion rule.

27. The method of claim 23, comprising dynamically changing scorings associated with respective internal regions based on a formula, thereby at least partly causing said dynamic varying to said conversion rule.

28. The method of claim 23, comprising providing a relative importance for each respective parameter, and dynamically varying said respective importance, thereby at least partly causing said dynamic varying to said conversion rule.

29. The method of claim 11, wherein said totalizer scale comprises a volume, wherein situations progress over time to delineate regions of said volume, and wherein a total is assessable from said delineated region.

30. The method of claim 11, wherein said totalizer scale comprises a volume, wherein situations are plotted through said volume, wherein said volume is delineated into a plurality of regions and wherein a current situation is assessable from a current presence of said situation within one of said regions within said volume.

31. The method of claim 30, said volume having a center and respective parameters being placed around said center, said regions being defined around the center such that measurements of respective parameters plot a location within the within the volume.

32. The method of claim 31, wherein respective regions are labeled as safe, and of gradated levels of concern.

33. The method of claim 32, wherein said defining and labeling of regions is based on a database comprising results from study of a population.

34. The method of claim 31, wherein said volume is an N-dimensional volume wherein N is at least three.

35. Measurement to graphical analysis method for monitoring a situation via mutually incompatible parameters, the method comprising, using an electronic processor and sensors:
obtaining momentary values of a plurality of parameters over a course of said situation;
transforming said measured momentary values into an assessment of said situation, by:
for each parameter defining a variation range of said parameter;
setting internal boundaries at any of substantially continuous locations along each variation range, said boundaries defining a plurality of internal regions within said variation ranges;
dynamically changing said internal boundaries over said course;
applying scores to respective ones of said internal regions;
dynamically changing said scores over said course;
providing scaling for calculating a contribution from each parameter to a total, said total attained by combining scaled scores from momentary values of each parameter, said scaling describing each parameter's relative importance to said situation such that said scaling is changed for different situations, said scaling providing a mutually compatible output allowing said mutually incompatible parameters to be compared; and
outputting said total graphically as a plot over regions of varied levels of importance; thereby to provide a graphically presented monitoring of said situation.
